(19) United States
(12) Patent Application Publication
(10) Pub. No.: US 2009/0106138 A1
(43) Pub. Date: Apr. 23, 2009

(54) Transaction authentication over independent network

(76) Inventors: Steven E. Smith, Phoenix, AZ (US); Terry L. Davis, Scottsdale, AZ (US)

Correspondence Address: ETHERTON LAW GROUP, LLC, 5555 E. VAN BUREN STREET, SUITE 100, PHOENIX, AZ, 85008, US

(21) Appl. No.: 12/288,660

(22) Filed: Oct. 22, 2008

Related U.S. Application Data
(60) Provisional application No. 60/999,866, filed on Oct. 22, 2007.

(51) Int. Cl. G06Q 20/00

(52) U.S. Cl. 705/35

(57) ABSTRACT

A method of authenticating an online transaction over a first network uses 2-factor authentication of the user to defeat hacker attacks. A communication device is registered for use with the method. The communication device is configured to receive messages over a second network independent of the first network. The user is authenticated over the first network using a first factor, such as a username and password, and then initiates the transaction. A request to execute the transaction is received and a one-time password is obtained to be used as a second factor of authentication. The one-time password and details describing the transaction are sent to the communication device over the second network. The one-time password is received from the user over the first network to complete the second factor of authentication.

### CROSS-REFERENCE TO RELATED APPLICATIONS

This application claims the benefit of co-pending provisional application No. 60/999,866 filed Oct. 22, 2007.

### FIELD OF INVENTION

This invention relates to transaction verification and user authorization. This invention relates particularly to methods of authenticating a user in an online transaction using an independent network.

### BACKGROUND

An online transaction, wherein “online” means over the internet or another network accessible by a personal computer, is generally perceived as “risky” because the vendor cannot verify that the user and the payment instrument are not physically present at the point of sale, so the vendor cannot empirically verify that the payor's name on the payment instrument is that of the user. It is desirable to reduce the risk level as much as possible, particularly for online financial transactions such as direct payment services offered by the user's financial institution, credit card transactions, and debit card transactions. Systems for authentication of the user are implemented in order to decrease the risk involved in the online transaction. It has become generally known in the field of secured online transactions that a single-factor authentication system, typically using private information such as a username and password or information identifying a financial account, is insufficient protection for users conducting financial transactions over the internet because it is easily compromised by various “hacking” attacks.

This is driving the implementation of “2-factor” authentication technologies that combine a first factor known only to the user, such as a user name and password, with a second factor that is separately and securely obtained by the user. A common 2-factor scheme for online security is use of a one-time password (“OTP”). In typical OTP systems, the user carries an electronic device that generates a different OTP each time the user logs on. The user can only log on if he has two authentication factors, namely a valid OTP generated by the electronic device and a valid username. These systems use cryptographic technology, wherein the OTP is generated based on a predetermined encryption scheme, so that an authentication server that knows the encryption scheme can verify that the OTP is valid for that user. Once the OTP is used, it is no longer valid. Therefore, stolen OTPs are useless.

One problem with a 2-factor authentication system using a physical electronic OTP-generating device is that it is too expensive for a large corporation, such as a financial institution or major retailer, to issue and manage the devices for its entire customer base. Instead, corporations may opt for managing a single OTP-generating device that sends their users OTPs via a network that is independent of the internet. For example, a corporation may send OTPs by text message to the users' cell phones. The cell phone essentially functions as the aforementioned electronic device, but the corporation does not have to purchase, issue, or manage the device itself. There are several systems that offer this technology, all of which use the OTP in conjunction with a username and password to allow the user to log on and access his account.

Unfortunately, unauthorized participants, referred to herein as “hackers,” have developed “Man in the Middle” (“MITM”) attacks that can defeat these OTP systems. In an MITM attack, the hacker sets up a website that interposes itself between a financial institution or merchant and its customers, and takes control of the session at login while maintaining the appearance of a valid transaction to both valid parties. The MITM can make it appear to the customer that all of his transactions are posted correctly, while some or all of the money or goods are sent to the hacker's account (which has been previously setup using counterfeit or stolen credentials). MITM tools are now available to hackers on the internet, and no current commercial solution exists. A method of 2-factor authentication is needed that overcomes the online transaction's susceptibility to MITM attacks. Further, the method should allow the user to verify that his transactions posted correctly and subsequently authorize them to be executed.

Therefore, it is an object of this invention to provide a method of user authentication for secure online transactions using an independent network. It is a further object that the method uses 2-factor authentication. It is a further object that the method be able to secure direct payments from an account as well as credit- and debit-initiated transactions. It is another object to provide a method that enables the user to verify that the correct transactions were received and authorize the transactions. It is a further object that the method is feasible for a financial institution or merchant with a large customer base to implement. Another object of the invention is to authenticate users over an independent network in a way that defeats MITM attacks.

### SUMMARY OF THE INVENTION

A method of two-factor authentication protects a user conducting transactions over the internet by sending a one-time password (“OTP”) and a list of the transactions to the user at or near the completion of the transaction. A first factor of authentication is performed over the internet to allow the user to conduct the transactions. The user then requests the transactions using the internet or a network that is independent of the internet. The OTP and a list of the transactions are sent over the independent network. The independence of the network and inclusion of the transaction details with the OTP prevents hackers, who have gained unauthorized access to the internet transaction, from altering or adding transactions. Preferably, a cellular telephone network is used to transmit the OTP and the list of transactions. The user receives the OTP and list of transactions, verifies that the transactions are correctly listed, and authorizes execution of the transactions by entering the OTP. The OTP is received over the internet and a second factor of authentication is performed by checking that the OTP is valid, and if so, the payment portion of the transaction is conducted. The OTP is a single-use key that ceases to function once a transaction or specified series of transactions is completed or canceled by the user.

### BRIEF DESCRIPTION OF THE DRAWINGS

FIG. 1 is a flow diagram of the present method.

FIG. 2 is an illustration of a system using the present method.

FIG. 3 is an illustration of a system using an alternative embodiment of the method.

FIG. 4 is a flow diagram of the preferred embodiment of the present method.

FIG. 5 is an illustration of a system using the preferred embodiment of the present method.

FIG. 6 is a front view of a cellular phone displaying a text message.

FIG. 7 is a front view of a computer screen displaying a confirmation web page.

FIG. 8 is an illustration of an alternative system using the preferred embodiment of FIG. 4.

### DETAILED DESCRIPTION OF THE INVENTION

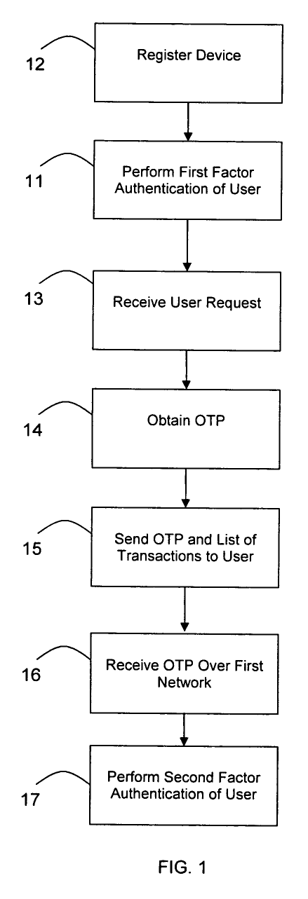

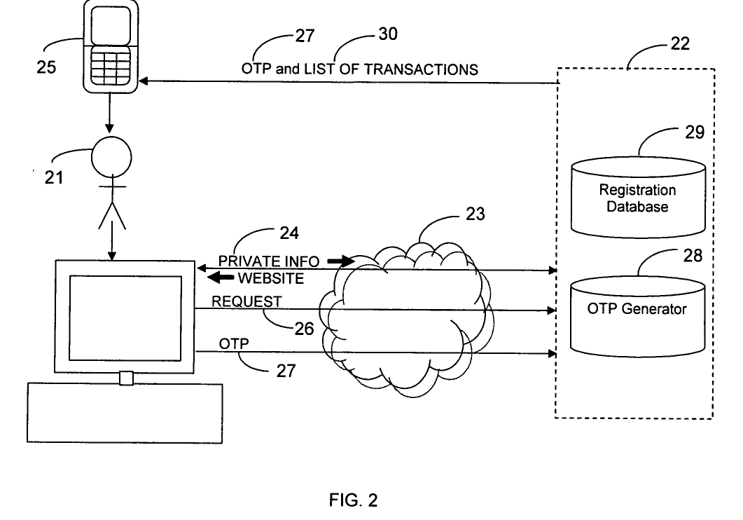

Referring to FIGS. 1-3, there is illustrated the present inventive method for user authentication in online transactions over a first network. The method may be used by a financial institution, debit card issuer, credit card or other payment processor, or a merchant (herein referred to collectively as a “vendor”), to ensure that the party requesting execution of one or more transactions is actually the authorized user. The method uses a second network independent of the first network to authenticate the user. As it is used in this description and the appended claims, a second network is “independent of” a first network if, when the first and second networks transmit different data between common endpoints, an unauthorized user who attacks the first network and gains access to the data on the first network cannot also gain access to the data on the second network using the same attack.

An authentication system 22 registers 12 a communication device 25 associated with a user 21 for use in the present method. The authentication system 22 may be a standalone server or other computer system, or it may be a software or hardware component that is added to an existing computer framework. To register 12 the communication device 25, the authentication system 22 receives an identifier from the user 21, the identifier being used to contact the communication device 25. Preferably, the identifier is a phone number assigned to the communication device 25, but the identifier may also be an email address, short code, MAC address, hardware serial number, or other unique address used by the communication device 25 to receive messages. The registration 12 may be conducted over the first or second network or by a method independent of both networks. Additional security measures may be implemented to identify the user 21 if the user 21 is not present during registration 12. For example, the authentication system 22 may ask the user 21 several identifying questions if registration 12 is conducted over the internet 23. Preferably, the authentication system 22 receives the identifier during a face-to-face meeting with the user 21, such as in a bank branch or at the merchant's store. The authentication system 22 stores the identifier in a registration database 29.

The first network is any network on which the user may conduct online transactions, such as the internet, an intranet or virtual private network, a cellular phone network, or a land-line telephone network, but is preferably the internet 23. The communication device 25 may be any device that at least receives, but preferably sends and receives, data over the second network. Where the first network is the internet 23, the communication device 25 is a device that uses a network that is independent of the internet, such as a land-line telephone, digital telephone, satellite telephone, pager, cell phone, or personal data assistant. These example devices may use an analog or digital branch of the public switched telephone network (“PSTN”), a text messaging network such as short message service (“SMS”), simple mail transfer protocol (“SMTP”) or another email transfer protocol. PSTN and SMS are examples of networks that are physically independent of the internet 23. Further, it should be recognized that a cellular network and similar multiple-layer networks may be used for both the first and second networks. For example, the cellular network Global System for Mobile communications (“GSM”) has several layers, each of which carries different communication protocols. The GSM layers, including SMS and packet-switching for internet access, are isolated from each other and thus retain their independence. Further, the internet 23 itself is a multi-layer network, wherein SMTP is isolated from and independent of other transmission layers such as hypertext transfer protocol. The present invention therefore contemplates that the first and second networks may be the internet 23 if the protocols used are independent of each other.

The registration database 29 or a separate database may be used to keep track of how many users are registered, whether each user's status is active or inactive (described below), and which users have passed authentication 11 and are currently logged in. The registration database 29 may be a standalone database located on the authentication system 22. Preferably, the registration database 29 is implemented as an additional schema within an existing database in which the vendor maintains its user information, and the vendor grants read, write, and update permissions to the authentication system 22.

The user 21 desires to execute transactions through the vendor's website and first enters private information 24 over the first network. The private information 24 serves as the first factor of authentication for the online transactions. In one embodiment, the private information 24 is a standard user name and password, used to gain access to online functionality provided by the vendor. Such functionality includes online financial transactions, medical or other confidential information transmissions, stock or securities trading, and access to meetings, collaborative documents, or other business functions. The private information 24 may grant access to a previously-stored personal account that is configured to be accessed online. Alternatively, the private information 24 may be used for single-session identification of the user 21. In this case, the private information 24 may be payment information, such as a credit or debit card number and billing address, bank account number, check routing number, or other information that identifies the user and the account that should be used in the transactions.

The authentication system 22 configured to perform the present method performs a first factor of authentication 11 of the user 21 using the private information 24. To perform the first factor of authentication 11 of the user 21, preferably the vendor validates the user's 21 private information 24 and the authentication system 22 receives notification from the vendor that the private information 24 has been validated. Alternatively, the authentication system 22 may itself validate the private information 24 by checking that it matches stored information relating to the user 21. For example, where the private information 24 is the user's 21 username and password, the authentication system 22 compares it to the stored username and password and allows the user 21 to log on if the private information 24 matches the stored information.

As part of performing the first factor of authentication 11, the authentication system 22 may also check the registration database 29 or another database to see if the user's 21 status is active or inactive. At registration 12, the user 21 is marked as active, but can be inactivated by request or through a process that marks the user 21 as inactive if the provided identifier can no longer be used to contact the user's 21 communication device 25. For example, the authentication system 22 may use a disconnect list provided by an SMS aggregator to identify cell phone numbers that have recently been disconnected from their respective users. The authentication system 22 compares the numbers to identifiers in the registration database 29 and marks matching users as inactive. The authentication system 22 then informs any users marked as inactive that they must re-register, using other previously-provided contact information such as a billing address, email address, or alternate phone number. Preferably, a disconnect list processor receives the disconnect lists from all of the SMS aggregators, extracts the phone numbers from the disconnect lists, and informs the authentication system 22 which phone numbers have been disconnected.

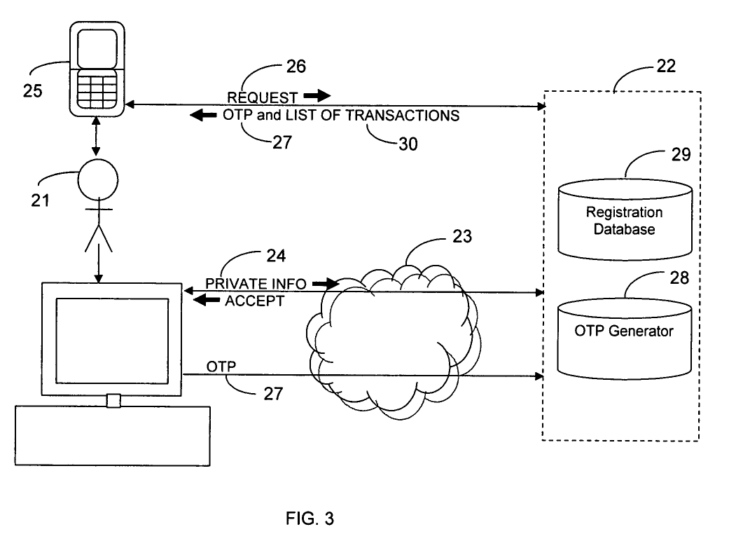

The authentication system 22 receives 13 a request 26 from the user 21 notifying the authentication system 22 that the user 21 wishes to conduct one or more online transactions using a one-time password (“OTP”) 27 as a second factor of authentication for the online transactions. The request 26 may be generated after the user 21 enters transaction details for each transaction he wishes to conduct and then presses a “submit” button on the website. In this case, the vendor's website software may parse the transaction details and include them in the request 26. The request 26 is received with or after the private information 24. Preferably, the request 26 is received 13 after performing the first-factor authentication 11 of the user 21, so that the authentication system 22 knows that the first factor of authentication has already been successfully passed. The request 26 may be received 13 over the first network or over the second network. Alternatively, as shown in FIG. 3, the request 26 is received 13 over the second network from the communication device 25. In this embodiment, the request 26 may be an express request for the OTP 27, i.e. “please send the OTP to my registered device immediately,” or simply “OTP.” The transaction details would therefore be transmitted separately from the request 26, and preferably when the user submits the private information 24. Transaction details will vary depending on the type of vendor using the present method. In a financial transaction, transaction details typically include the account number that is the source of funds, payee information, and the amount of money to transfer. The examples below provide some illustration.

If the user's 21 status is active, the authentication system 22 obtains 14 the OTP 27 using an OTP generator 28. The OTP generator 28 may be software residing on the authentication system 22 or another computer system to which the authentication system 22 has access, or it may be an external hardware security module. The OTP generator 28 may generate the OTP 27 using any suitable method of generating an OTP that is now known or later adopted by the industry, such as a software- or hardware-based randomizer, preset algorithms, or selection from a database that contains OTPs conforming to a desired format. In the preferred embodiment, described below, the OTP generator 28 uses an internal secure algorithm based on a cryptographic key that is unique to the authentication system 22. The OTP 27 and transaction details contained in the request 26 may be associated with the user 21 by storing them in the registration database 29. If the user 21 has requested execution of multiple transactions in the request 26, the OTP 27 will authenticate all transactions in the request 26.

The authentication system 22 then sends 15 the OTP 27 and the transaction details to the user's 21 registered communication device 25 over the second network. Preferably, the OTP 27 and transaction details are sent in a text message to the communication device 25. Alternatively, the OTP 27 and transaction details may be formatted to transmit to communication devices 25 in other formats. For example, the OTP 27 may be electronically recorded using interactive voice response (“IVR”) technology or a pre-recorded voice, or called in to the user by a live person such as a vendor employee. Preferably, the transaction details sent with the request 26 are formatted into a list of transactions 30 that are sent with the OTP 27 in the text message. The user 21 receives the text message and can verify that the list of transactions 30 match the transaction request he entered. If the user 21 wishes to execute the transaction or series of transactions associated with the OTP 27, he authorizes the transactions by entering the OTP 27 online.

After sending 15 the OTP 27 and list of transactions 30, the authentication system 22 waits to receive 16 the OTP 27 over the first network. In the period between sending 15 and receiving 16 the OTP 27, if the user 21 attempts to initiate another set of transactions before completing the outstanding transactions in the request 26, the authentication system 22 may invalidate the OTP 27, essentially aborting the transactions in the request 26.

The authentication system 22 receives 16 the OTP 27 over the first network and performs a second factor of authentication 17 of the user 21. The authentication system 22 checks that the OTP 27 it received is valid for that user 21 and set of transactions; in other words, that the received 16 OTP 27 matches the obtained 14 OTP 27. If so, the authentication system 22 notifies the vendor that the user 21 is authenticated and has authorized the transactions to be executed. The execution will depend on the type of vendor using the method, and may be a simple instruction to another processor or may initiate a complex process involving financial transfers, shipping of goods, and other activity. Some examples are described below. The authentication system 22 invalidates the OTP 27 once it is used. Further, if the user 21 cancels the transaction or does not complete it before logging out, the OTP 27 becomes invalid.

The foregoing detailed description is a broad explanation of the inventive method. It should be read to encompass equivalent methods of providing similar functionality, including the receipt, storage, and delivery of data. The preferred embodiment is described below, followed by an example wherein the vendor is a financial institution implementing the preferred embodiment of the method.

### Preferred Embodiment

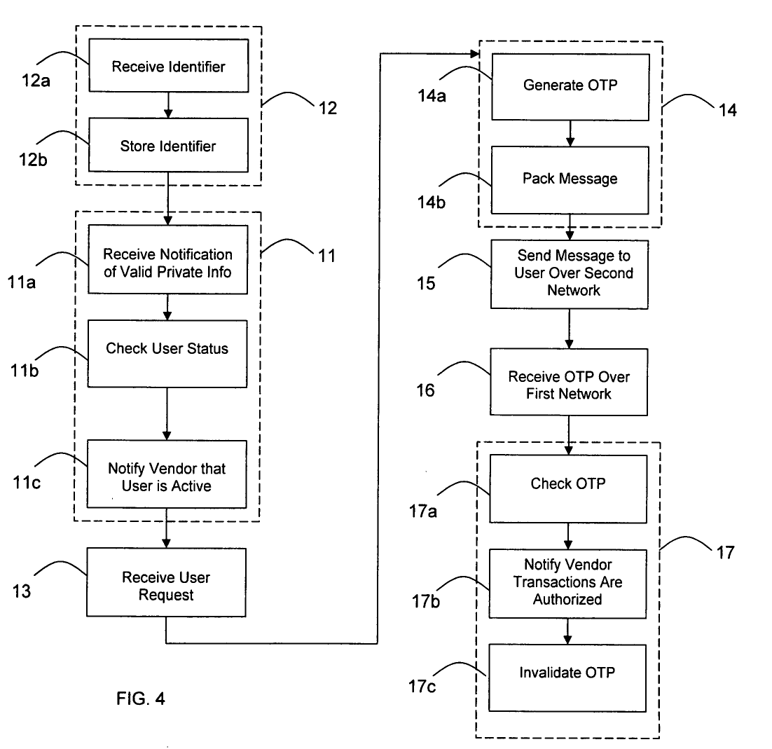

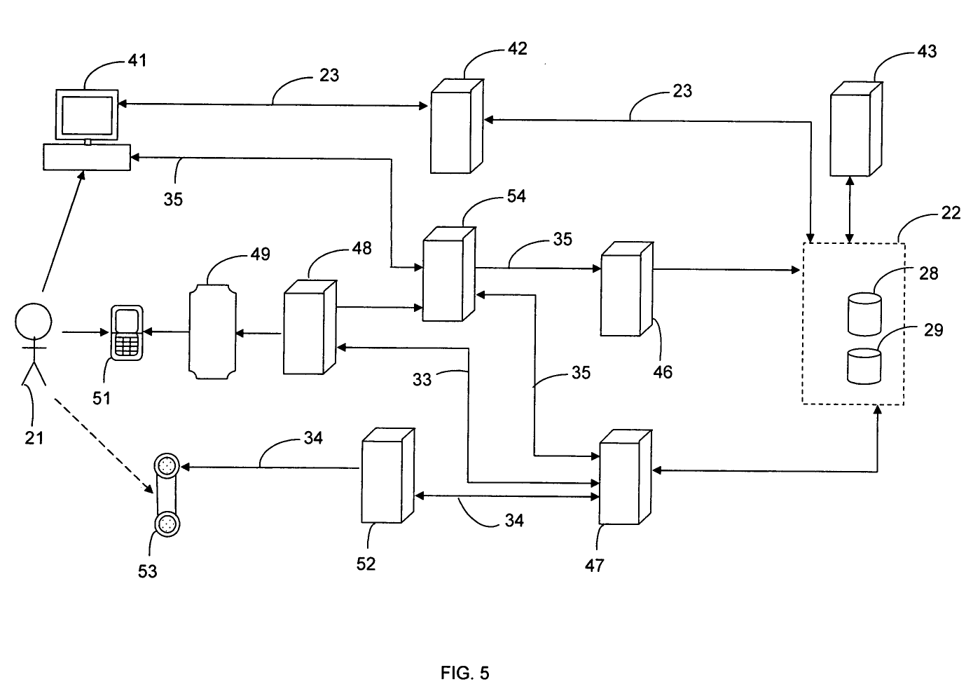

Referring to FIGS. 4-7, there is illustrated the preferred embodiment of the method and the collection of networks and computer systems over which it may be performed. The authentication system 22 first registers 12 the user's 21 cell phone 51 for use in the method by receiving 12a the phone number of the cell phone 51 from the vendor's central computer system 43. Upon receipt 12a of the phone number the authentication system 22 stores 12b it in the registration database 29.

The vendor's web server 42 hosts web content including the vendor's web page and a login page that are sent over the internet 23 to the user's computer 41 when the user 21 points his web browser to the vendor's web address. The web server 42 is configured so that data can be sent back and forth between the authentication system 22 and web server 42 over the internet 23. The authentication system 22 performs the first factor authentication 11 of the user 21 by first receiving 11a notification from the web server 42 that the user 21 has correctly entered private information 24. Then the authentication system 22 checks 11b that the user 21 is active. Most preferably, the authentication system 22 maintains user status information by receiving a list of disconnected phone numbers from a disconnect processor 46. The disconnect processor 46 parses a disconnect list received through an email server 54 from aggregators 48 and formats the information for use by the authentication system 22. The authentication system 22 notifies 11c the vendor that the user 21 is active and the authentication system 22 is prepared to accept a request 26.

The authentication system 22 is a Tomcat server configured to run the web services and web applications used to perform the method. The authentication system 22 is protected by at least one firewall (not shown), as is known in the art, so that one or more web services may run on the authentication system 22 and interact with system administrators or vendor employees who are authorized to access the web services, but the web services will not be accessible by people or computers on the internet 23 outside the firewalls. The authentication system 22 uses SOAP, formerly Simple Object Access Protocol, calls for all remote procedure calls and other messages originating from or received by the web services running on the authentication system 22. When the authentication system 22 communicates with computer systems that are exposed to the internet 23, such as the web server 42, all SOAP calls are encrypted by secure socket layer (“SSL”) or Axis2 data encryption.

The authentication system 22 receives 13 a request 26 to execute the user's 21 desired transactions from the web server 42 over the internet 23. The request 26 is initiated by the user 21 entering the desired transactions into the web application and submitting them. The request 26 has been formatted by the web server 42 and contains data identifying the user 21 and the transaction details.

The authentication system 22 obtains 14 an OTP 27 for the user's 21 transactions by first generating 14a the OTP 27 using the OTP generator 28. The OTP generator 28 contains a built-in secure algorithm that follows these steps:
1. Read a stored key that is unique to the authentication system 22;
2. Process the stored key through a secure hash algorithm to obtain an encryption key that is specific to the authentication system 22;
3. Increment an internal OTP counter;
4. Encrypt the internal OTP counter using the encryption key and 128-bit Advanced Encryption Standard, resulting in a set of random bytes;
5. Select characters for the OTP from an indexed character set, using the random bytes as indices.
   The OTP 27 uses a length and set of valid characters that are chosen by the vendor.

After the OTP 27 is generated 14a, the authentication system 22 packs 14b the OTP 27 and list of transactions 30 into a message that is formatted for delivery over the appropriate second network. Because the user 21 has provided his cell phone 51 number as the identifier, the SMS network 33 is an appropriate second network and the authentication system 22 packs 14b the OTP 27 and list of transactions 30 into an SMS text message.

The authentication system 22 then sends 15 the text message containing the OTP 27 and list of transactions 30 to the cell phone 51 using the stored phone number. The text message is first delivered to a messaging gateway 47 that functions as an interface between the authentication system 22 and the possible second networks. The messaging gateway 47 is configured to handle messages that are to be delivered via SMS network 33, PSTN 34, or SMTP 35, and maintains a connection with each of these networks. The messaging gateway 47 can also send packed 14b messages to a third-party IVR processor 52 for conversion from text to voice content before the message is then delivered over the PSTN 34 to the user's 21 telephone 53. In this example, the messaging gateway 47 examines the incoming text message and passes it to the SMS network 33. The messaging gateway 47 also generates status messages stating whether or not incoming messages were successfully passed to the appropriate network and sends the status messages back to the authentication system 22.

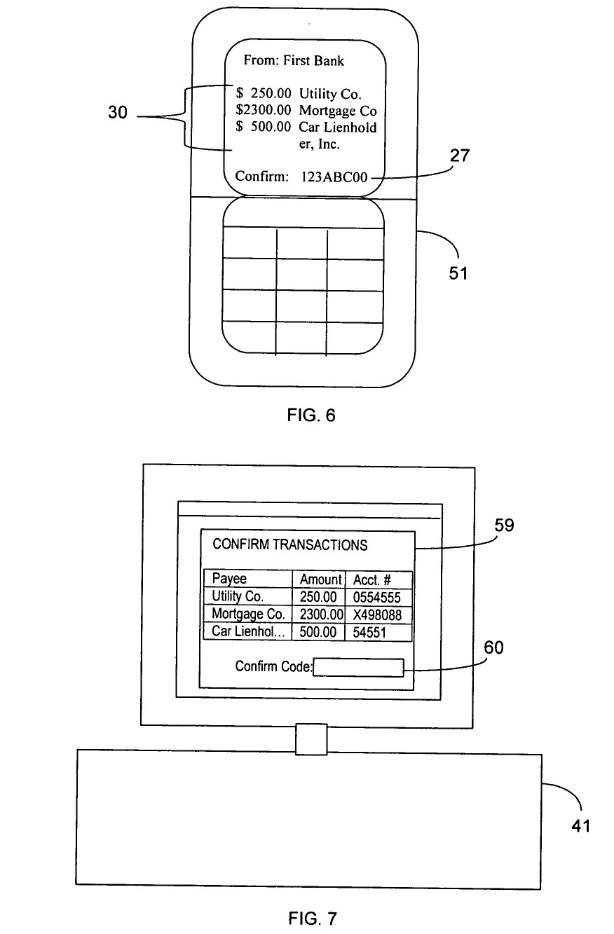

The text message passes via the SMS network 33 to an SMS aggregator 48. The aggregator 48 delivers the text message to the cell phone 51 carrier 49, which delivers the message to the cell phone 51. As shown in FIG. 6, the user 21 views the text message on the cell phone 51, verifies that the entered transactions are correct, and authorizes the transactions by entering the OTP 27 into a confirmation web page 59 sent to the user's 21 computer 41 by the web server 42. Most preferably, the confirmation web page 59 appears on the user's computer 41 screen after he has submitted the request 26, and the confirmation web page 59 contains a box 60 for entering the OTP 27. See FIG. 7.

The authentication system 22 then receives 16 the OTP 27 over the internet 23 and performs the second factor of authentication 17 of the user 21 by checking 17a to see that the OTP 27 is valid and then sending 17b notification to the vendor's central computer system 43 that the user 21 is authentication and has authorized the transactions to be executed. The authentication system 22 also invalidates 17c the OTP 27 after it is successfully used.

### EXAMPLE 1

### Financial Institution and Account Holder

Referring to FIGS. 4-7, the method is used by a financial institution having a website and an internet application, both hosted on the web server 42, that allow account holders to make payments out of their accounts online. The user 21 opens an account through a financial institution employee. As part of the account setup, the user 21 gives the employee the identifier for his communication device 25, which is the phone number for the user's 21 cell phone 51. The user's cell phone 51 is capable of receiving text messages over an SMS network 33. The employee enters the phone number into the authentication system 22, which registers 12 the cell phone 51 by storing the phone number in the registration database 29.

Later, the user 21 decides to pay three bills from his account using the financial institution's website and internet application. The bills are $250.00 owed to Utility Co., $2300.00 owed to Mortgage Co., and $500.00 owed to Car Lienholder, Inc. The user 21 points an internet browser to the financial institution's website and is asked to log in. The user 21 enters his username and password as private information 24 and presses a “Log In” button. The web server 42 verifies the private information 24 and notifies the authentication system 22, which performs the first factor of authentication 11 of the user 21. The user 21 creates a payment request 26 in the internet application and enters transaction information for all three bills, listing each payee, his account number with the payee, and the amount to pay, and presses a “Submit” button. A confirmation web page 59 appears on the user's 21 screen with a box 60 to enter the OTP 27.

The authentication system 22 receives 13 the request 26 over the internet 23. The authentication system 22 obtains 14 the OTP 27 and sends 15 the OTP 27 and the transaction details from the request 26 to the user's 21 registered cell phone 51 in a text message over the SMS network 33. The text message appears on the cell phone 51 screen as illustrated in FIG. 6. The user 21 verifies that the three bills he wants to pay are correctly displayed. If so, the user 21 authorizes the transactions by entering the OTP 27 into the confirmation web page 59 box 60 and presses “Submit” again. The authentication system 22 receives 16 the OTP 27 and performs the second factor of authentication 17 of the user. The OTP 27 can only be used to authenticate the user for performing the authorized transactions that are described in the request 26. Any attempt to authorize other transactions using the OTP 27 will fail the second factor of authentication and be denied. This method defeats a MITM that would attempt to alter or add transactions by verifying the desired transactions over an independent network to which the MITM cannot gain access.

### EXAMPLE 2

### Debit Over Internet, Request Over Second Network

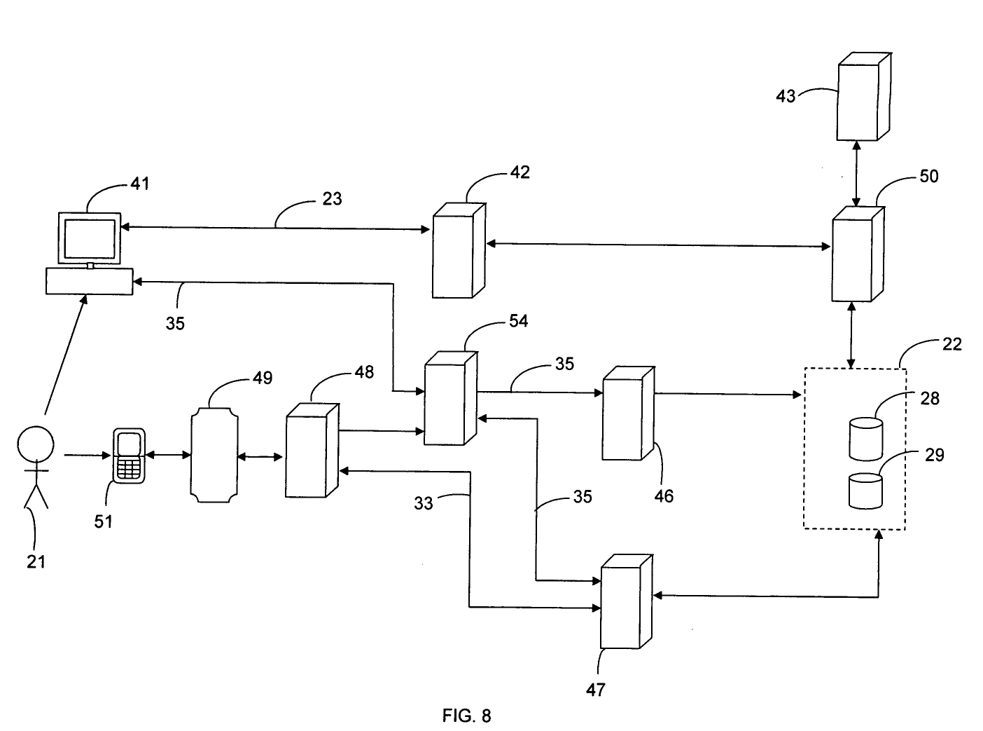

Referring to FIGS. 4 and 8, the method is used by a financial institution to allow account holders to use their debit cards to make purchases from an online merchant that has been evaluated and approved by the financial institution. The merchant has a website and an internet application, both hosted on the web server 42, that allow the user to open and access an online account with the merchant.

The user 21 visits a location of the financial institution and opens an account through an employee. As part of the account setup, the user 21 receives a debit card and sets his permanent PIN. Further, to use his debit card online, the user 21 gives the employee the identifier for his communication device 25, which is the phone number for the user's 21 cell phone 51. The user's cell phone 51 is capable of receiving text messages over an SMS network 33. The employee enters the user 21 information, debit card number, and phone number into the financial institution's central computer system 43. The financial institution then supplies the user's 21 phone number and debit card number to a merchant processor 50. The merchant processor 50 serves as an intermediary between the merchant and the financial institution, and is in charge of “clearing” debit transactions conducted by the merchant by requesting authorization for the funds transfer from the financial institution. The merchant processor 50 controls the authentication system 22, which registers 12 the cell phone 51 by storing the phone number in the registration database 29.

Later, the user 21 decides to buy goods from the merchant via the merchant's website. The user 21 selects the goods and comes to a checkout page, where the user 21 enters his debit card number, the name on the card, the expiration date, and the billing address as payment information. The web server 42 sends the payment information to the merchant processor 50 to determine that it is correct. If it is correct, the authentication system 22 receives 11a notification over the internet 23 that the user 21 has properly submitted the payment information. The authentication system 22 checks 11b that the user 21 is active and notifies 11c the merchant that the user 21 may pay with his debit card. The authentication system 22 then receives the transaction details from the web server 42.

The merchant's website instructs the user 21 to request an OTP 27. The authentication system 22 then receives 13 the request 26 for the OTP 27 via text message over the SMS network 33. The authentication system 22 recognizes that the request 26 originated from the user's 21 registered cell phone 51.

The authentication system 22 obtains 14 the OTP 27 and sends 15 the OTP 27 and the transaction details to the user's 21 cell phone 51 in a text message over the SMS network 33. The user 21 verifies that the transactions are correct and authorizes the transactions by entering the OTP 27 as his debit card PIN instead of using his permanent PIN. The authentication system 22 receives 16 the OTP 27 over the internet 23 from the merchant's web server 42. The authentication system 22 checks 17a the OTP 27 and, if it is correct, notifies 17b the merchant processor 50 that it may execute the transactions. Finally, the authentication system 22 invalidates 17c the OTP 27.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiments disclosed, but that the invention will include all embodiments falling within the scope of the appended claims.

We claim:

1. A method of authenticating an online transaction, the method comprising:
a) registering a communication device associated with a user;
b) receiving transaction details for the online transaction;
c) receiving a request made by the user;
d) performing a first factor of authentication of the user;
e) obtaining a one-time password (“OTP”);
f) sending the OTP and the transaction details to the communication device;
g) receiving the OTP; and
h) performing a second factor of authentication of the user when the OTP is received.

2. The method of claim 1 wherein registering the communication device comprises receiving an identifier that is used to contact the communication device.

3. The method of claim 1 wherein the transaction details are received over a first network.

4. The method of claim 3 wherein sending the OTP and the transaction details to the communication device occurs over a second network independent of the first network.

5. The method of claim 4 wherein receiving the request occurs over the first network and the request comprises the transaction details.

6. The method of claim 4 wherein the first network is the internet;

7. The method of claim 6 wherein the second network is a telephone voice network.

8. The method of claim 6 wherein the second network is a text messaging network.

9. The method of claim 8 wherein sending the OTP and transaction details to the communication device comprises packing the OTP and transaction details into a text message.

10. The method of claim 1 wherein performing the first factor of authentication comprises receiving notification that private information entered by the user over a first network has been validated.

11. The method of claim 10 wherein receiving the request occurs after performing the first factor of authentication.

12. The method of claim 11 wherein receiving the request occurs over a second network that is independent of the first network.

13. A method of authenticating online transactions, the method comprising:
a) registering a communication device associated with a user;
b) performing a first factor of authentication of the user, comprising:
i. receiving notification that private information entered by the user over the internet has been validated; and
ii. checking that the user is active;
c) receiving a request comprising transaction details, the request having been entered by the user and received via the internet;
d) obtaining a one-time password (“OTP”) from an OTP generator;
e) sending the OTP and the transaction details to the communication device over a second network that is independent of the internet;
f) receiving the OTP via the internet; and
g) performing a second factor of authentication of the user when the OTP is received, comprising checking that the OTP is valid.

14. The method of claim 13 wherein:
a) the second network is a text messaging network;
b) the communication device is capable of receiving text messages over the second network; and
c) sending the OTP and transaction details to the communication device occurs over the second network and comprises packing the OTP and transaction details into a text message.

15. The method of claim 13 wherein:
a) the second network is a voice telephone network;
b) the communication device is a land-line telephone; and
c) sending the OTP and transaction details to the communication device occurs over the voice telephone network and comprises packing the OTP and transaction details into a voice message.

16. The method of claim 13 wherein the private information entered by the user comprises a username and password.

17. The method of claim 13 wherein the private information entered by the user comprises payment information.

18. A method of authenticating online transactions, the method comprising:
a) registering a communication device associated with a user;
b) performing a first factor of authentication of the user, comprising:
i. receiving notification that private information entered by the user over the internet has been validated; and
ii. checking that the user is active;
c) receiving transaction details via the internet;
d) after performing the first factor of authentication of the user, receiving a request for a one-time password (“OTP”) from the user over a second network that is independent of the internet;
e) obtaining the OTP from an OTP generator;
f) sending the OTP and the transaction details to the communication device over the second network;
g) receiving the OTP via the internet; and
h) performing a second factor of authentication of the user when the OTP is received, comprising checking that the OTP is valid.

19. The method of claim 18 wherein:
a) the second network is a text messaging network;
b) the communication device is a cellular telephone capable of sending and receiving text messages over the text messaging network;
c) receiving the request over the second network comprises receiving a text message from the communication device over the text messaging network; and
d) sending the OTP and transaction details to the communication device occurs over the text messaging network and comprises packing the OTP and transaction details into a text message.

20. A method of 2-factor authentication of online transactions between a user and a vendor, the method comprising:
a) registering a cell phone of the user, the cell phone being configured to receive text messages over a text messaging network that is independent of the internet, the registering comprising:
i. receiving a phone number assigned to the cell phone from the user; and
ii. storing the phone number in a registration database;
b) after registering the cell phone, performing a first factor of authentication of the user, comprising:
i. receiving notification that private information entered by the user over the internet has been validated; and
ii. checking that the user is active;
c) receiving over the internet transaction details for one or more online transactions involving the user's account;
d) receiving a request for a one-time password (“OTP”);
e) if the user is active, generating the OTP;
f) packing the OTP and the transaction details into a text message;
g) sending the text message to the cell phone over the text messaging network;
h) receiving the OTP from the user over the internet; and
i) performing a second factor of authentication of the user, comprising:
i. checking that the OTP is valid;
ii. if the OTP is valid, notifying the vendor that the transactions may be executed; and
iii. invalidating the OTP.

21. The method of claim 20 wherein receiving the request for the OTP occurs over the internet.

22. The method of claim 20 wherein receiving the request for the OTP occurs over the text messaging network.
